(19) United States
(12) Patent Application Publication
(10) Pub. No.: US 2025/0323520 A1
(43) Pub. Date: Oct. 16, 2025

(54) OUTPUT CONTROL METHOD

(71) Applicant: TOYOTA JIDOSHA KABUSHIKI KAISHA, Toyota-shi (JP)

(72) Inventor: Junichi MATSUO, Okazaki-shi (JP)

(73) Assignee: TOYOTA JIDOSHA KABUSHIKI KAISHA, Toyota-shi (JP)

(21) Appl. No.: 19/009,163

(22) Filed: Jan. 3, 2025

(30) Foreign Application Priority Data
Apr. 12, 2024 (JP) 2024-064843

(51) Int. Cl. H02J 7/00

(52) U.S. Cl. CPC H02J 7/007192; H02J 2300/30

(57) ABSTRACT

An output control method for controlling a fuel cell system, the fuel cell system comprising: a fuel cell; a converter connected between the fuel cell and a load and boosting the supplied electric power from the fuel cell; a secondary cell connected to the fuel cell via the converter in parallel with the load; and an auxiliary device connected to the fuel cell via the converter and being supplied with electric power from the secondary battery to drive the auxiliary device, wherein the output control method comprises: determining use permitted power at which an output voltage of the secondary battery is not equal to or less than a predetermined threshold value when a predetermined restriction condition related to the driving condition of the auxiliary device is satisfied; and executing restriction control for controlling the output electric power of the secondary battery in accordance with the permitted use electric power.

### CROSS-REFERENCE TO RELATED APPLICATION

This application claims priority to Japanese Patent Application No. 2024-064843 filed on Apr. 12, 2024, incorporated herein by reference in its entirety.

### BACKGROUND

### 1. Technical Field

The present disclosure relates to an output control method.

### 2. Description of Related Art

Hitherto, there has been known a fuel cell system that includes a fuel cell and a secondary battery, and in which the secondary battery is connected to a drive motor without intermediation of a converter (for example, Japanese Unexamined Patent Application Publication No. 2023-146166 (JP 2023-146166 A)). Electric power generated in the fuel cell system is supplied to an auxiliary device for operating the fuel cell system in addition to the drive motor.

### SUMMARY

In such a system, the voltage of the secondary battery may decrease, for example, when the output power from the secondary battery is large. In this case, the output of the fuel cell system may decrease. For example, the output of the auxiliary device required for the fuel cell operation may decrease.

The present disclosure can be implemented in the following aspects.

(1) One aspect of the present disclosure provides an output control method for controlling a fuel cell system configured to supply electric power to a load. In the output control method,
the fuel cell system includes:
a fuel cell;
a converter connected between the fuel cell and the load and configured to boost electric power supplied from the fuel cell;
a secondary battery connected to the fuel cell via the converter in parallel to the load; and an auxiliary device connected to the fuel cell via the converter, connected to the secondary battery, and driven by being supplied with electric power from the secondary battery.
   The output control method includes:
determining use permitted power at which an output voltage of the secondary battery is not equal to or lower than a predetermined threshold value when a predetermined limit condition related to a drive status of the auxiliary device is satisfied; and
performing limiting control for limiting output power of the secondary battery according to the use permitted power.
   In the output control method of this aspect, the use permitted power at which the output voltage of the secondary battery is not equal to or lower than the predetermined threshold value is determined when the limit condition is satisfied, and the limiting control for limiting the output power of the secondary battery is performed according to the use permitted power. Therefore, it is possible to reduce the occurrence of a case where the output voltage of the secondary battery is equal to or lower than the predetermined threshold value and the output of the auxiliary device decreases, and to reduce the occurrence of a case where the output of the fuel cell system decreases.

(2) In the above embodiment,
the limiting control need not be performed when a predetermined limit relaxation condition is satisfied while the limit condition is satisfied.
   In the output control method of this aspect, the limiting control is not performed when the predetermined limit relaxation condition is satisfied while the limit condition is satisfied. Therefore, it is possible to reduce the occurrence of a case where the limiting control and the normal control are frequently switched and the operation of the fuel cell system is unstable.

(3) In the above embodiment,
the limit condition may include a condition that the fuel cell is generating electric power and required power of the auxiliary device is equal to or higher than a predetermined threshold value.
   In the output control method of this aspect, the limit condition includes the condition that the fuel cell is generating electric power and the required power of the auxiliary device is equal to or higher than the predetermined threshold value. Therefore, it is possible to reduce the occurrence of a case where the output of the fuel cell system decreases due to an increase in the required power of the auxiliary device.

(4) In the above embodiment,
the auxiliary device may include a cooling medium pump configured to supply a cooling medium to the fuel cell, and
the limit relaxation condition may include at least one of:
a condition that a period in which the output voltage of the secondary battery is equal to or lower than the predetermined threshold value due to an increase in the output power of the secondary battery is equal to or shorter than a predetermined threshold period;
a condition that a temperature of the auxiliary device is equal to or lower than a predetermined auxiliary device threshold temperature; and
a condition that a temperature of the cooling medium supplied by the cooling medium pump is equal to or lower than a predetermined cooling medium threshold temperature.
   In the output control method of this aspect, the limiting control is not performed when at least one of the first condition, the second condition, and the third condition is satisfied. In this case, it is possible to reduce the occurrence of a case where the limiting control and the normal control are frequently switched and the operation of the fuel cell system is unstable. The first condition is that the period in which the output voltage of the secondary battery is equal to or lower than the predetermined threshold value due to the increase in the output power of the secondary battery is equal to or shorter than the predetermined threshold period. The second condition is that the temperature of the auxiliary device is equal to or lower than the predetermined auxiliary device threshold temperature. The third condition is that the temperature of the cooling medium supplied by the cooling medium pump is equal to or lower than the predetermined cooling medium threshold temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view showing an outline of a fuel cell system according to an embodiment of the present disclosure; and

FIG. 2 is a flowchart illustrating a procedure of the output control method according to the present embodiment.

### DETAILED DESCRIPTION OF EMBODIMENTS

### A. Embodiment

### A-1. System Configuration:

The fuel cell system 100 of the present embodiment is mounted on a fuel cell electric vehicle, for example, an automobile, a bus, a truck, or the like. The fuel cell system 100 may be mounted on various moving bodies other than the vehicle, for example, a train, a ship, an airplane, or a stationary fuel cell device independent of a system power supply.

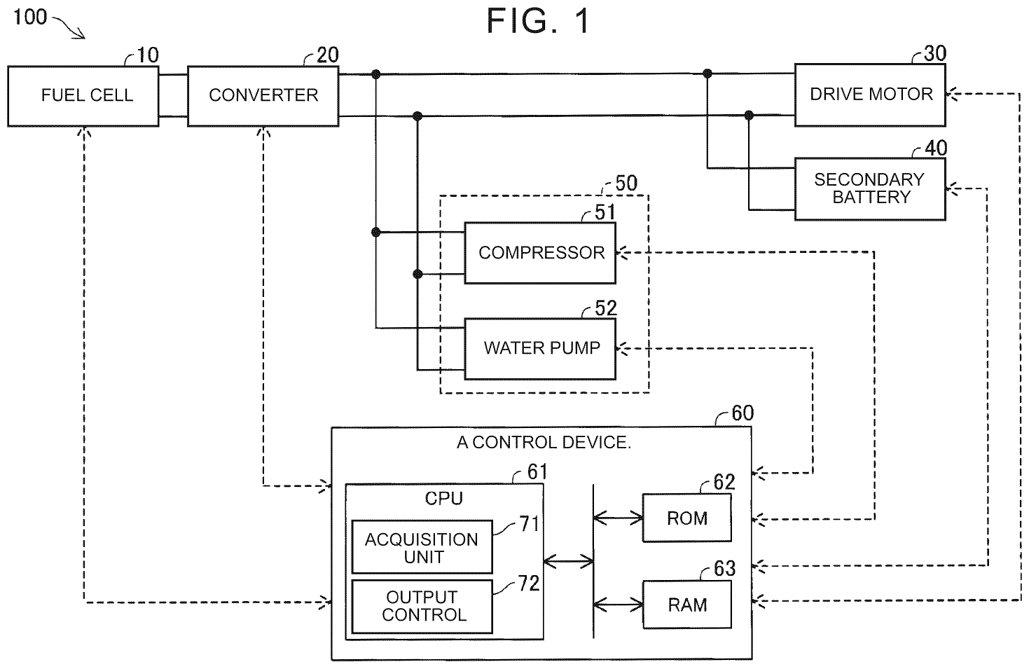

FIG. 1 is an explanatory diagram schematically showing a fuel cell system 100 according to the present embodiment. As illustrated in FIG. 1, the fuel cell system 100 includes a fuel cell 10, a converter 20, a drive motor 30, a secondary battery 40, an auxiliary device 50, and a control device 60. The control device 60 is configured to be able to communicate with the fuel cell 10, the converter 20, the drive motor 30, the secondary battery 40, and the auxiliary device 50 described above.

The fuel cell 10 has a stack structure in which a plurality of fuel cells is stacked. The fuel cell 10 generates electric power by chemically reacting a fuel gas and an oxidizing gas in a plurality of fuel cell cells. In the fuel cell system 100 of the present embodiment, hydrogen gas is used as the fuel gas, and air is used as the oxidizing gas. In FIG. 1, a fuel gas supply pipe for supplying a fuel gas, an oxidizing gas supply pipe for supplying an oxidizing gas, and a coolant circulation pipe for circulating coolant as a cooling medium for cooling the fuel cell 10 are omitted.

The converter 20 is connected between the fuel cell 10 and the drive motor 30, boosts the power supplied from the fuel cell 10, and supplies the boosted power to the drive motor 30, the secondary battery 40, and the auxiliary device 50. The drive motor 30 is a motor for driving a vehicle on which the fuel cell system 100 is mounted. The drive motor 30 corresponds to a “load” in the present disclosure.

The secondary battery 40 is, for example, a lithium-ion secondary battery or a nickel-hydrogen secondary battery. The secondary battery 40 is connected to the fuel cell 10 via the converter 20, and is connected to the drive motor 30 in parallel with the converter 20. The secondary battery 40 functions as a power source for driving the drive motor 30 and the auxiliary device 50. The secondary battery 40 performs charging and discharging according to the required power of the drive motor 30 and the auxiliary device 50 and the amount of power generated by the fuel cell 10. The charging and discharging of the secondary battery 40 is controlled by the control device 60 controlling the output voltage of the converter 20.

The auxiliary device 50 is a device arranged in each part of the fuel cell system 100. In the present embodiment, the fuel cell system 100 includes a compressor 51 and a water pump 52 as the auxiliary device 50. Note that the auxiliary device 50 included in the fuel cell system 100 is not limited to the above, and may include various devices such as a hydrogen on-off valve installed in a fuel gas supply pipe to control a supply amount of the fuel gas, a radiator installed in a coolant circulation pipe to cool the coolant, and the like.

The compressor 51 is installed in the oxidizing gas supply pipe described above, and supplies air to the fuel cell 10. The compressor 51 is controlled by the control device 60 to adjust the amount of air supplied to the fuel cell 10. In the present embodiment, the compressor 51 is driven by being supplied with electric power from at least one of the fuel cell 10 and the secondary battery 40. The compressor 51 includes a temperature sensor (not shown) and outputs the body temperature of the compressor 51 to the control device 60.

The water pump 52 is installed in the coolant circulation pipe described above, and supplies the coolant to the fuel cell 10. The water pump 52 that supplies coolant as a cooling medium corresponds to a “cooling medium pump” in the present disclosure. The cooling medium supplied to the fuel cell 10 is not limited to water, and may be antifreeze water such as ethylene glycol, air, insulating oil, or the like. The water pump 52 is controlled by the control device 60 to adjust the amount of coolant supplied to the fuel cell 10. In the present embodiment, the water pump 52 is driven by being supplied with electric power from at least one of the fuel cell 10 and the secondary battery 40. Further, the water pump 52 has a temperature sensor (not shown), and outputs the body temperature of the water pump 52 and the water temperature of the coolant supplied by the water pump 52 to the control device 60.

The control device 60 controls the fuel cell system 100. The control device 60 is configured as a computer including a CPU 61, a ROM 62, and a RAM 63. The control device 60, by executing and expanding the program stored in advance in ROM 62 to RAM 63, the acquisition unit 71, and the output control unit 72, functions as. Note that the control device 60 also includes functional units that execute various controls related to the operation of the fuel cell system 100 described above, but in FIG. 1, functional units related to execution of an output control method described later are illustrated, and illustration of other functional units is omitted.

The acquisition unit 71 acquires auxiliary device drive information. The “auxiliary device drive information” means information related to driving of the auxiliary device 50. In the present embodiment, the acquisition unit 71 acquires information as auxiliary device drive information. This information includes the required power of the compressor 51 and the water pump 52, the body temperature of the compressor 51 and the water pump 52, and the temperature of the coolant supplied by the water pump 52. The required power of each of the compressor 51 and the water pump 52 is specified, for example, in accordance with the required power generation amount of the fuel cell 10 calculated in accordance with the required output of the drive motor 30.

The output control unit 72 executes an output control method, which will be described later, and controls the output power of the fuel cell system 100 in accordance with the acquired auxiliary device drive information.

### A-2. Output Control Method:

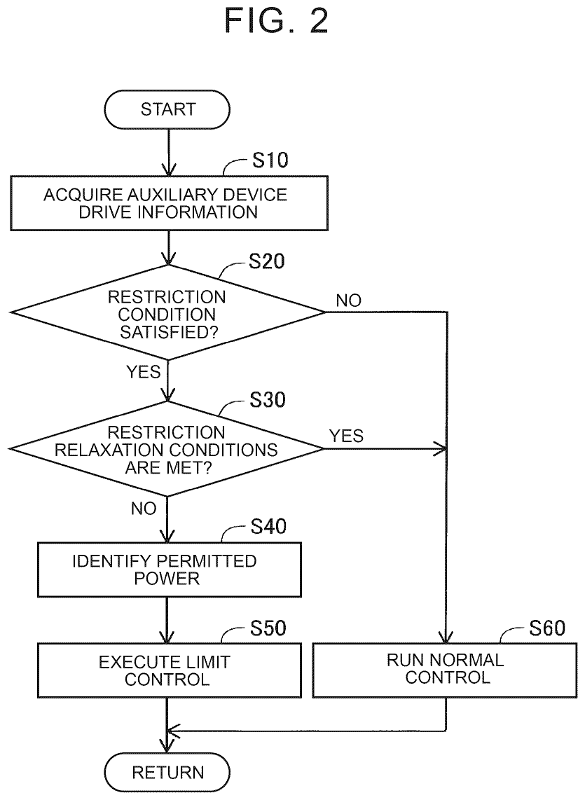

FIG. 2 is a flowchart illustrating a procedure of the output control method according to the present embodiment. The output control method is started when the operation of the fuel cell system 100 is started, and is repeatedly executed while the fuel cell system 100 is in operation.

In S10, the acquisition unit 71 acquires the above-described auxiliary device drive information.

In S20, the output-control unit 72 determines whether or not the limiting condition is satisfied in accordance with the acquired auxiliary device drive information. In the present embodiment, the output control unit 72 determines, as a restriction condition, whether the fuel cell 10 is generating electric power and the required electric power by the auxiliary device 50 is equal to or more than a predetermined threshold value.

When the required power from the auxiliary device 50 is high and the secondary battery 40 is rapidly discharged, the electrolyte in the secondary battery 40 is biased in ion concentration, and the battery performance is lowered, and the output voltage of the secondary battery 40 is lowered. Therefore, the output voltage of the entire fuel cell system 100 decreases, the driving current of the auxiliary device 50 increases, the auxiliary device 50 generates heat, and the driving of the auxiliary device 50 can be restricted to prevent the auxiliary device 50 from overheating. As a result, the operation of the fuel cell system 100 may be hindered, and the operation of the fuel cell system 100 may not be continued.

In order to avoid such a situation, restriction control described later is executed. In the fuel cell system 100 of the present embodiment, the above-described restriction condition is set in advance as a condition indicating that such restriction control should be performed, and in S20, the output control unit 72 determines whether or not such restriction condition is satisfied.

When it is determined that the restriction condition is not satisfied (S20: No), in S60, the output-control unit 72 executes the normal-time control without executing the restriction control described later. In the normal-time control, the output control unit 72 controls the output voltage of the converter 20 so as to maximize the power generation efficiency by the fuel cell 10, for example, in accordance with the required electric power by the auxiliary device 50 and the drive motor 30. After completion of S60, the above-described S10 is executed again.

If it is determined that the restriction condition is satisfied (S20: Yes), in S30, the output control unit 72 determines whether or not the restriction relaxation condition is satisfied. The “restriction relaxation condition” is set in advance as a condition indicating that the restriction control does not need to be executed immediately even if the above-described restriction condition is satisfied. In the present embodiment, as the restriction relaxation condition, it is determined whether or not all the conditions among the following conditions (1) to (3) are satisfied.
(1) The time when the output voltage of a secondary battery becomes below a predetermined threshold value by the increase in the output power of a secondary battery is below a predetermined threshold value time
(2) The body temperature of the auxiliary device 50 is equal to or lower than a predetermined auxiliary device threshold temperature
(3) The temperature of the coolant supplied by the water pump 52 is equal to or lower than a predetermined refrigerant threshold temperature

When it is determined that the restriction relaxation condition is satisfied (S30: Yes), more specifically, when all of the conditions (1) to (3) are satisfied, the output control unit 72 executes the above-described S60. That is, in the present embodiment, even when the above-described restriction condition is satisfied, when the restriction relaxation condition is satisfied, the output control unit 72 does not execute the restriction control described later.

When the above condition (1) is satisfied, since the time for lowering the output voltage of the secondary battery 40 is short, it can be said that the influence on the operation of the fuel cell system 100 is small even if the drive current in the auxiliary device 50 increases as described above. Note that the “time when the output voltage of the secondary battery 40 becomes equal to or lower than the predetermined threshold value” is specified by using, for example, the required output power and the required output time in the output request from the drive motor 30 and the auxiliary device 50. Further, when the conditions of the above conditions (2) and (3) are satisfied, since the body temperature of the auxiliary device 50 is low, the driving of the auxiliary device 50 is not restricted immediately even if the auxiliary device 50 generates heat due to an increase in the driving current, and it can be said that the influence on the operation of the fuel cell system 100 is small.

That is, when all of the conditions (1) to (3) are satisfied, it can be said that the influence on the operation of the fuel cell system 100 is small even when the above-described restriction condition is satisfied, so that the output control unit 72 does not execute the above-described restriction control. Therefore, it is possible to prevent the operation of the fuel cell system 100 from becoming unstable due to frequent switching between the restriction control and the normal-time control.

When it is determined that the restriction relaxation condition is not satisfied (S30: No), more specifically, when at least one of the conditions (1) to (3) is not satisfied, the output control unit 72 specifies the permitted use power of the secondary battery 40 in S40. In the present embodiment, the output control unit 72 determines the use permitted power using the acquired auxiliary device drive information so that the output voltage of the secondary battery 40 does not fall below a predetermined threshold value. In the present embodiment, the output control unit 72 determines the use permitted power by using the acquired auxiliary device drive information so that the output voltage of the secondary battery 40 falls within a predetermined appropriate range. By determining the use permission power using the auxiliary device drive information, it is possible to specify the use permission power in which the output voltage of the secondary battery 40 falls within a predetermined appropriate range and has an appropriate size according to the driving state of the auxiliary device 50.

In S50, the output-control unit 72 executes the limit control. “Limit control” means suppressing the output power of the secondary battery 40 in accordance with the determined use permitted power. In the present embodiment, the output control unit 72 controls the output voltage of the converter 20 so that the output power of the secondary battery 40 is equal to or less than the use permitted power. At this time, the output control unit 72 estimates the output voltage of the secondary battery 40 from the resistance value of the secondary battery 40 and the sweep current of the secondary battery 40, and performs feedback control of the output voltage of the secondary battery 40 using the estimated output voltage. The resistance value of the secondary battery 40 and the sweep current of the secondary battery 40 are detected by an electrical resistance sensor (not shown) and a current sensor (not shown) provided in the fuel cell 10. After completion of S50, the above-described S10 is executed again.

According to the output control method in the fuel cell system 100 of the embodiment described above, when the restriction condition is satisfied, the use permitted power in which the output voltage of the secondary battery 40 does not fall below a predetermined threshold value is specified. Then, restriction control for controlling the output power of the secondary battery 40 in accordance with the use permitted power is executed. Therefore, it is possible to prevent the output voltage of the secondary battery 40 from falling below a predetermined threshold and the output of the auxiliary device 50 from falling, and to prevent the output of the fuel cell system 100 from falling.

In addition, since the restriction control is not executed when the predetermined restriction relaxation condition is satisfied, the restriction control and the control in the normal state are frequently switched, so that it is possible to prevent the operation of the fuel cell system 100 from becoming unstable.

### B. Other Embodiments

(B1) In the above-described embodiment, the output control unit 72 determines the use permission power by using the auxiliary device drive information, but the present disclosure is not limited to this. The use permitted power may be set in advance and stored in ROM 62. According to this aspect, it is possible to easily specify the permitted power to be used.

(B2) In the above-described embodiment, the output control unit 72 determines whether or not the restriction relaxation condition is satisfied, and does not execute the restriction control when the restriction relaxation condition is satisfied, but the present disclosure is not limited thereto. The output control unit 72 may not determine whether or not the restriction relaxation condition is satisfied, and may always execute the restriction control when the restriction condition is satisfied. According to this configuration, the output voltage of the secondary battery 40 becomes equal to or lower than a predetermined threshold value, and the output of the auxiliary device 50 can be suppressed from decreasing, and the output of the fuel cell system 100 can be suppressed from decreasing. In addition, since it is not determined whether or not the restriction relaxation condition is satisfied, an increase in the processing load in the control device 60 can be suppressed.

(B3) In the above-described embodiment, the output control unit 72 determines whether or not the fuel cell 10 is generating electricity and the required electric power by the auxiliary device 50 is equal to or higher than a predetermined threshold value as a restriction condition, but the present disclosure is not limited thereto. For example, the output control unit 72 may determine whether or not the body temperature of the auxiliary device 50 is equal to or higher than a predetermined threshold value as a restriction condition. That is, in general, the “restriction condition” means a condition related to a driving state of the auxiliary device 50. According to such a configuration, the restriction control can be executed when the body temperature of the auxiliary device 50 is equal to or higher than a predetermined threshold value, and the same effect as in the above-described embodiment can be obtained.

(B4) In the above-described embodiment, the output control unit 72 determines whether or not all of the conditions (1) to (3) are satisfied as the restriction relaxation condition, but the present disclosure is not limited thereto. The output control unit 72 may determine whether or not at least one of the conditions (1) to (3) is satisfied as the restriction relaxation condition. According to this embodiment, the same effects as those of the above-described embodiment can be obtained.

(B5) In the above embodiment, the fuel cell system 100 supplies power to the drive motor 30 as a load, but the present disclosure is not limited thereto. The fuel cell system 100 may provide power to any electrical device, such as a heater, as a load.

(B6) In the above-described embodiment, the fuel cell system 100 supplies electric power to the drive motor 30 as a load included therein, but the present disclosure is not limited thereto. The fuel cell system 100 may supply electric power to an external load provided outside the fuel cell system 100. According to this embodiment, the same effects as those of the above-described embodiment can be obtained.

The present disclosure is not limited to the embodiments above, and can be implemented with various configurations without departing from the scope of the present disclosure. For example, the technical features in the embodiments corresponding to the technical features in the respective embodiments described in the Summary of the Disclosure can be appropriately replaced or combined in order to solve some or all of the above-described problems. Alternatively, for example, the technical features in the embodiments corresponding to the technical features in the respective embodiments described in the Summary of the Disclosure can be appropriately replaced or combined in order to achieve some or all of the above-described effects. When the technical features are not described as essential in this specification, the technical features can be deleted as appropriate.

What is claimed is:

1. An output control method for controlling a fuel cell system configured to supply electric power to a load, the fuel cell system including
a fuel cell,
a converter connected between the fuel cell and the load and configured to boost electric power supplied from the fuel cell,
a secondary battery connected to the fuel cell via the converter in parallel to the load, and
an auxiliary device connected to the fuel cell via the converter, connected to the secondary battery, and driven by being supplied with electric power from the secondary battery, the output control method comprising:
determining use permitted power at which an output voltage of the secondary battery is not equal to or lower than a predetermined threshold value when a predetermined limit condition related to a drive status of the auxiliary device is satisfied; and
performing limiting control for limiting output power of the secondary battery according to the use permitted power.

2. The output control method according to claim 1, wherein the limiting control is not performed when a predetermined limit relaxation condition is satisfied while the limit condition is satisfied.

3. The output control method according to claim 1, wherein the limit condition includes a condition that the fuel cell is generating electric power and required power of the auxiliary device is equal to or higher than a predetermined threshold value.

4. The output control method according to claim 2, wherein:
the auxiliary device includes a cooling medium pump configured to supply a cooling medium to the fuel cell; and
the limit relaxation condition includes at least one of
a condition that a period in which the output voltage of the secondary battery is equal to or lower than the predetermined threshold value due to an increase in the output power of the secondary battery is equal to or shorter than a predetermined threshold period,
a condition that a temperature of the auxiliary device is equal to or lower than a predetermined auxiliary device threshold temperature, and
a condition that a temperature of the cooling medium supplied by the cooling medium pump is equal to or lower than a predetermined cooling medium threshold temperature.
